(19) United States
(12) Patent Application Publication
(10) Pub. No.: US 2007/0187989 A1
(43) Pub. Date: Aug. 16, 2007

(54) Deck for a vehicle

(76) Inventors: Dawn L. Brown, Kent City, MI (US); Tina Koomen, Kent City, MI (US)

Correspondence Address: ROBERT J. SAYFIE, P.C., 161 OTTAWA AVENUE NW, SUITE 407, GRAND RAPIDS, MI, 49503, US

(21) Appl. No.: 11/354,804

(22) Filed: Feb. 15, 2006

(51) Int. Cl. B60P 3/37

(52) U.S. Cl. 296/162

(57) ABSTRACT

A deck for a vehicle. The deck has planar surfaces that are hingedly connected so that the deck can be folded and placed in a stowed position at a rear end or side of the vehicle. The deck can be moved to a side of the vehicle by sliding the deck from the stowed position to the side via a guide rail secured to the underside of the vehicle. The deck can then be deployed or unfolded so as to lie in a substantially horizontal plane, where it can be used as a deck; i.e. for standing, walking, grilling, and to otherwise allow users to be supported by the deck.

### BACKGROUND OF THE INVENTION

This invention relates to a detachable and/or foldable vehicle deck that can be oriented so as to enable one to stand on it when in use; and that can be placed in a stowed position when not in use.

U.S. Pat. No. 4,883,306 discloses a Deck for Mobile Home. This deck pulls out from under the mobile home for use, where it is supported by legs having rollers. The deck retracts under the mobile home when not in use.

U.S. Pat. No. 6,736,446 discloses a deck that is stored beneath a vehicle when not in use. The deck is made of panels that fold in an accordion like manner. The deck may be pulled out for use. The deck may be adaptable to receive an upstanding side and a cover. This deck is not stowed at the rear of the vehicle, and does not have a guide rail underneath the vehicle to biasly support the deck.

However, deck storage underneath the vehicle reduces ground clearance and sometimes is impossible to position due to original equipment positioned under the vehicle, such as the gas tank, oil plug, and access to thereto.

As can be seen, there is a need for a deck that may be transported on an upstanding wall, such as the rear exterior wall or either the left or right side wall of the vehicle. And for use the deck may be securely moved via a guide rail or swivel member to a side of the vehicle for deployment.

Or alternatively, there is a need for a deck that may be transported inside a vehicle, and then moved outside of the vehicle for deployment and use.

### SUMMARY OF THE INVENTION

One aspect of the present invention is a deck for a vehicle, comprising: a plurality of planar surfaces hingedly connected to each other; a guide rail secured under the vehicle; a movement member having a guide rail end and a deck end, said deck end secured to said deck, said guide rail end biasly secured to said guide rail.

Another aspect is a method of deploying a deck for a vehicle, comprising the steps unsecuring said deck from a stowed position at a back end of the vehicle; moving said deck from said back end to a side of the vehicle by means of a guide rail secured underneath the vehicle; unfolding planar surfaces that are hingedly connected so that said planar surfaces are in a deployed position, said planar surfaces lie in substantially a horizontal plane above the earth, whereby said deck is capable of being moved from said deployed position to said stowed position and securing said deck in the stowed position.

These and other features, aspects and advantages of the present invention will become better understood with reference to the following drawings, description and claims.

### BRIEF DESCRIPTION OF THE DRAWINGS

FIG. 1 is a pictorial view of a deck in a stowed position;

FIG. 2 is a pictorial view of the deck in a deployed position;

FIG. 3 is another pictorial view of the deck in the deployed position;

FIG. 4 is a pictorial view of the underside of a vehicle; and

FIG. 5 is a cross-sectional view from FIG. 4.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

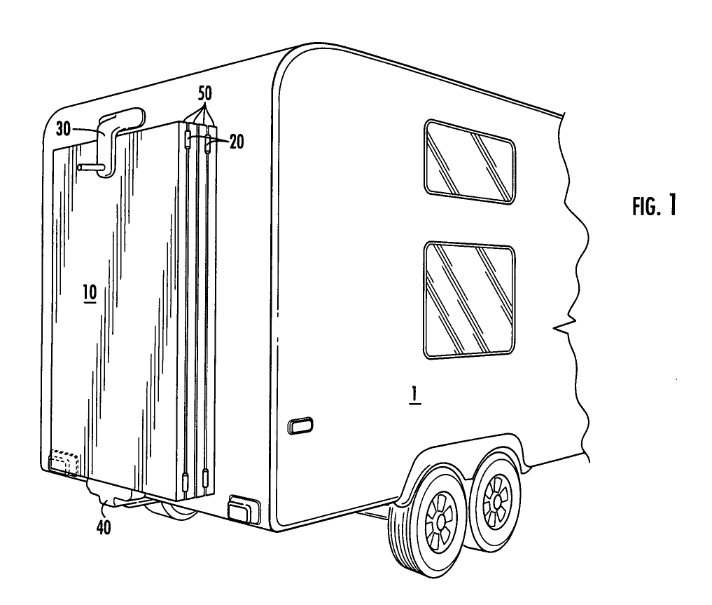

FIG. 1 illustrates one exemplary embodiment of the present invention whereby the deck 10 may be disposed at one of the upstanding walls. The upstanding walls are defined as either the rear exterior wall, or the exterior side walls (left or right). The deck may be secured adjacent to one of the upstanding walls when in the stowed position, i.e., not used as a deck 10. The deck 10 may be supported in this stowed position by a movement member 40, such as a swivel arm. Although FIG. 1 illustrates the deck 10 stowed adjacent the rear wall, the deck 10 may be stored adjacent either the left or right side wall.

A securing member 20 may retain the deck 10 in position when not in use. Here the deck 10 is illustrated in a stowed position. The deck 10 may be in the stowed position when it is not being used as a deck 10, such as when the recreational vehicle is traveling on the road.

The deck 10 may be comprised of separate planar surfaces 50 that may be hingedly connected by a hinge member 20. To deploy the deck 10 to be oriented in a substantially horizontal plane, and thus used as a deck 10, a movement member 40 has a guide rail end 70 and a deck end 80. In one exemplary embodiment the movement member 40 may be a swivel arm. In one exemplary embodiment the movement member 40 may have a universal ball joint to enable the deck 10 to be moved from the stowed—vertical position; to the operational—horizontal position. The guide rail end 70 may be secured either directly or indirectly to a guide rail 60. The deck end 80 is secured to the deck 10. In one exemplary embodiment the deck end 80 is secured to a planar surface 50.

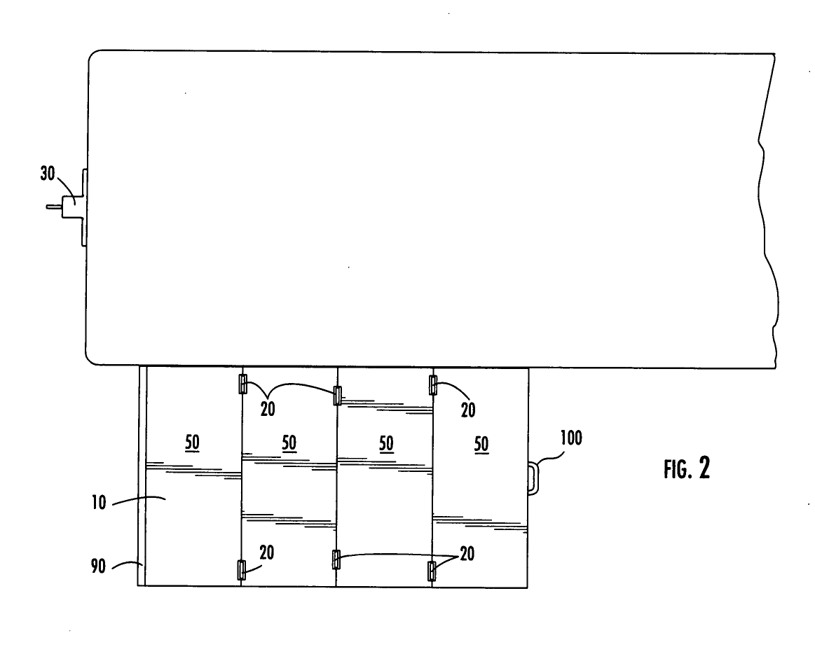

FIG. 2 illustrates a deck 10 as it is deployed horizontally adjacent to a side of the recreational vehicle. In one exemplary embodiment an arm 90 is disposed leftwardly of the deck 10. In one exemplary embodiment a handle 100 is disposed rightwardly of the deck 10.

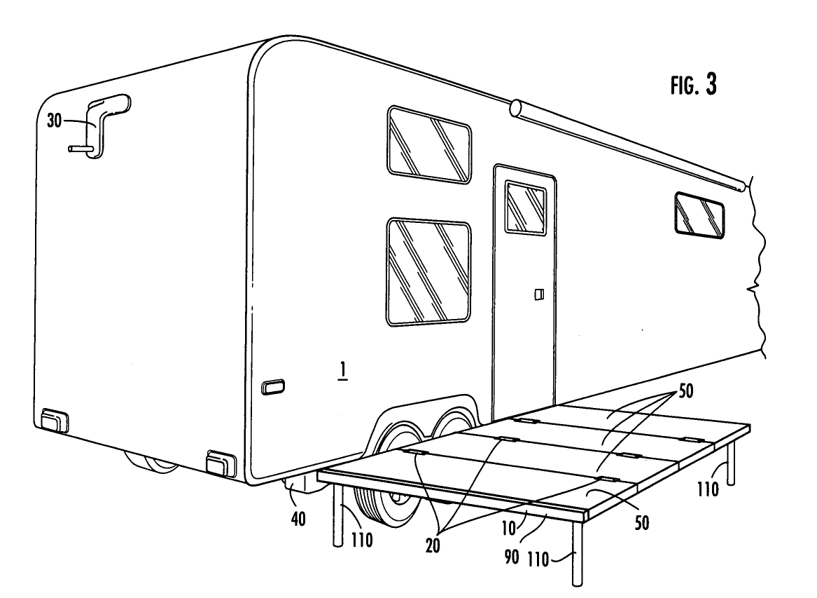

FIG. 3 is a pictorial view of the deck 10 disposed horizontally and deployed. A support member 110 may be secured beneath the deck 10 and above the ground to secure the deck 10 relative to the ground. In one exemplary embodiment the leg 110 may be secured to the deck. In one exemplary embodiment the support member 110 may be in rollable contact with the earth or other support beneath the deck 10. The support member may be a leg, leveler, stabilizer, or a combination thereof.

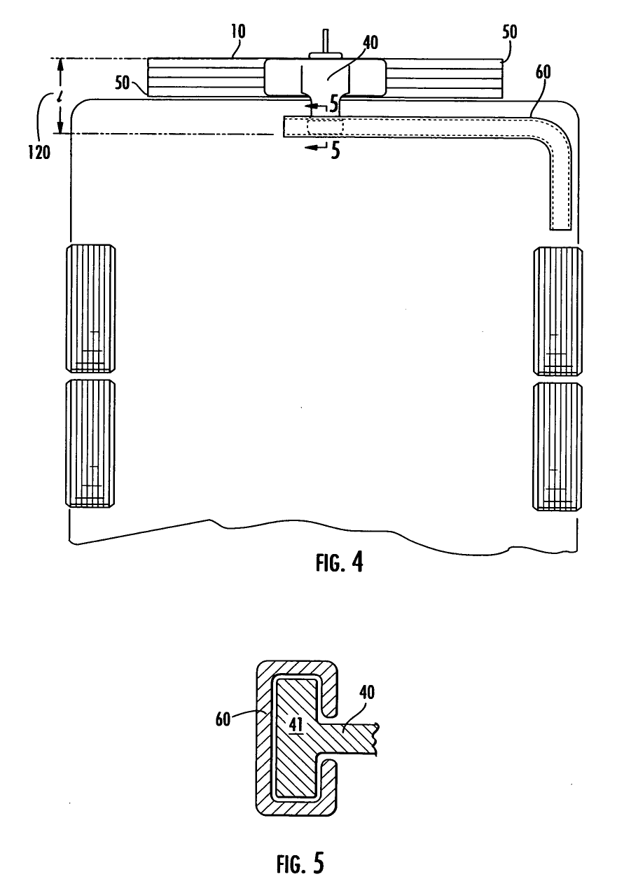

FIG. 4 illustrates a guide rail 60 that may enable the deck 10 to bias from its stowed position as shown in FIG. 1, to its deployed position as seen in FIG. 3. FIG. 5 is a cross-sectional view along line 5-5 on FIG. 4. FIG. 5 illustrates one exemplary embodiment as to how the movement member 40 may securely move relative to the guide rail 60. A length of the guide rail end 70 of the movement member 40 may vary to allow the deck 10 to be of sufficient distance from the recreational vehicle to be biased from the stowed position (FIG. 1) to the deployed position (FIG. 3).

Alternatively, the deck 10 may be folded up and stored inside the trailer.

In a further exemplary embodiment, the deck 10 may be detachable or removably secured to the deck end 80 of the movement member 40.

In one exemplary embodiment a hydraulic or pneumatic cylinder may be used to support and bias deck 10.

The deck 10 can be moved to a side of the vehicle by sliding the deck 10 from the stowed position (FIG. 1) to the side via the guide rail 60 secured to the underside of the vehicle. The deck 10 can have its planar surfaces 50 deployed or unfolded so as to lie in a substantially horizontal plane, where it can be used as a deck 10; i.e. for standing, walking, grilling, and to otherwise allow users to be supported by the deck 10.

The planar surfaces 50 may be comprised of a light weight rigid material, such as a plastic composite, or a wood-plastic composite, or a metal composite.

It should be understood, of course, that the foregoing relates to exemplary embodiments of the invention and that modifications may be made without departing from the spirit and scope of the invention as set forth in the following claims.

We claim:

1. A deck for a vehicle, comprising:
a plurality of planar surfaces hingedly connected to each other;
a guide rail secured under the vehicle;
a movement member having a guide rail end and a deck end, said deck end secured to one of said planar surfaces, said guide rail end movably secured to said guide rail; and
a securing member secured to an upstanding wall of the vehicle, whereby said plurality of planar surfaces can be folded and placed in a stowed position adjacent to said upstanding wall, and when in said stowed position said securing member secures said plurality of planar surfaces adjacent to said upstanding wall.

2. The deck of claim 1, wherein said upstanding wall is the exterior rear wall of the vehicle.

3. The deck of claim 1, further comprising a support member removably secured to a planar surface to support said planar surface.

4. The deck of claim 1, further comprising a hinge member to hingedly connect one planar surface to another.

5. The deck of claim 1, further comprising a hydraulic cylinder integrated with said movement member and at least one planar surface, said hydraulic cylinder capable of force division so as to ease manual movement of said deck.

6. The deck of claim 1, further comprising a pneumatic cylinder integrated with said movement member and at least one planar surface, said hydraulic cylinder capable of force division so as to ease manual movement of said deck.

7. The deck of claim 1, wherein said securing member is comprised of a strap having one end secured to the vehicle, and the other end to at least one planar surface.

8. The deck of claim 1, further comprising a handle disposed on one planar surface to aid in deploying said deck.

9. The deck of claim 1, further comprising a securing member capable of securing said plurality of planar surfaces relative to an upstanding wall of the vehicle.

10. The deck of claim 1, wherein the movement member is a swivel arm.

11. The deck of claim 1, wherein said upstanding wall is the exterior left wall of the vehicle.

12. The deck of claim 1, wherein said upstanding wall is the exterior right wall of the vehicle.

13. A method of deploying a deck for a vehicle, comprising the steps:
unsecuring said deck from a stowed position adjacent the vehicle;
moving said deck from the stowed position to a side of the vehicle by means of a guide rail secured underneath the vehicle;
unfolding planar surfaces that are hingedly connected so that said planar surfaces are in a deployed position, while in said deployed position said planar surfaces lie in a substantially horizontal plane above the earth, whereby said deck is capable of being moved from said deployed position to said stowed position and securing said deck in the stowed position.

14. A deck for a vehicle, comprising:
a plurality of planar surfaces hingedly connected to each other.

15. The deck of claim 14, further comprising:
a guide rail secured under the vehicle;
a movement member having a guide rail end and a deck end, said deck end capable of being secured to one of said planar surfaces, said guide rail end capable of being movably secured to a guide rail that is secured under the vehicle; and
a securing member that is capable of being secured to an upstanding wall of the vehicle, whereby said plurality of planar surfaces can be folded and placed in a stowed position adjacent to said upstanding wall, and when in said stowed position said securing member secures said plurality of planar surfaces adjacent to said upstanding wall.

16. The deck of claim 14, wherein said upstanding wall is the exterior rear wall of the vehicle.

17. The deck of claim 14, further comprising a support member removably secured to a planar surface to support said planar surface.

18. The deck of claim 14, further comprising a hinge member to hingedly connect one planar surface to another.

19. The deck of claim 14, further comprising a hydraulic cylinder integrated with said movement member and at least one planar surface, said hydraulic cylinder capable of force division so as to ease manual movement of said deck.

20. The deck of claim 4, further comprising a pneumatic cylinder integrated with said movement member and at least one planar surface, said hydraulic cylinder capable of force division so as to ease manual movement of said deck.
